(19) United States
(12) Patent Application Publication
(10) Pub. No.: US 2018/0306224 A1
(43) Pub. Date: Oct. 25, 2018

(54) Slide-in fastener for use in cabinet assembly

(71) Applicant: David Oliver Boone, Chesapeake, VA (US)

(72) Inventor: David Oliver Boone, Chesapeake, VA (US)

(21) Appl. No.: 15/955,201

(22) Filed: Apr. 17, 2018

Related U.S. Application Data
(60) Provisional application No. 62/488,004, filed on Apr. 20, 2017.

(51) Int. Cl. F16B 12/24; A47B 47/00

(52) U.S. Cl. CPC F16B 12/24; A47B 47/0075

(57) ABSTRACT

A system for slide-in fastening includes a first furniture member including slide-in dowels, each including a cut-out surface, an entry cut, a rear cut; a second furniture member with slide-in inserts, each including an entry opening and interior, and a target opening and interior, such that the dowels insert into entry interiors and slide sideways into the target interiors to hold the first and second furniture members securely together. Also disclosed is a method for manufacturing slide-in dowels, including inserting cylindrical dowels and machining exposed ends.

### CROSS-REFERENCE TO RELATED APPLICATIONS

This U.S. Non-Provisional application claims the benefit of U.S. Provisional Application No. 62/488,004, filed Apr. 20, 2017; which is hereby included herein by reference in its entirety.

### FIELD OF THE INVENTION

The present invention relates generally to the field of cabinet and furniture construction, and more particularly to fastening devices, methods and systems for use in cabinet and furniture assembly.

### BACKGROUND OF THE INVENTION

Traditionally, some cabinets are assembled using dowels and glue, in a time consuming and expensive process that is not suitable for do-it-yourself users. Other modern manufacturing methods rely on cam connectors that, although simple in use, do not produce a stable fastening function, and generally will loosen significantly after shipping, disassembly and reassembly. Other modern connectors may function well, but are complex and time consuming to manufacture.

As such, considering the foregoing, it may be appreciated that there continues to be a need for novel and improved devices and methods for fastening devices, methods and systems for use in cabinet and furniture assembly.

### SUMMARY OF THE INVENTION

The foregoing needs are met, to a great extent, by the present invention, wherein in aspects of this invention, enhancements are provided to the existing model of fastening systems and devices for assembly of cabinets and other furniture.

In an aspect, a system for slide-in fastening can include:
a) a first furniture member, which can be a first cabinet piece, such as a horizontal cabinet top/bottom, wherein the first furniture member includes:
   a plurality of slide-in dowels protruding from an end of the first furniture member; and
b) A second furniture member, which can be a second cabinet piece, such as a vertical cabinet side, wherein the second furniture member comprises:
   a plurality of slide-in insert, each inserted in inserts apertures that are positioned on an end of a side of the second furniture member;
wherein the insert apertures can be substantially figure-eight shaped, comprising overlapping first and second circular apertures, which can be of similar or different diameter, such that the insert apertures serve to orient vertical alignment of the slide-in inserts;
wherein the slide-in inserts are figure-eight shaped and configured to be insertable into the insert apertures, the slide-in inserts each comprising an entry opening, which connects to an entry interior, and a target opening, which connects to a target interior, such that the entry and target interiors are connected along an elongated direction;
such that the first furniture member is attachable to the second furniture member by inserting each of the plurality of slide-in dowels through a corresponding entry opening, such that each dowel reaches into an entry interior of a slide-in insert, and then push the first furniture member sideways, in direction of and parallel to a lateral axis of the slide-in insert, such that the slide-in dowels each slide from the entry interior into a target interior, such that the dowels are each securely held in place inside a corresponding target interior;
whereby, the first furniture member is securely attached to the second furniture member.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a slide-in fastening system prior to assembly, according to an embodiment of the invention.

FIG. 2 is a perspective view of a slide-in fastening system after assembly, according to an embodiment of the invention.

FIG. 3A is a front top perspective view of a slide-in dowel of the slide-in fastening system, according to an embodiment of the invention.

FIG. 3B is a front bottom perspective view of a slide-in dowel of the slide-in fastening system, according to an embodiment of the invention.

FIG. 4A is a side view of a slide-in dowel of the slide-in fastening system, according to an embodiment of the invention.

FIG. 4B is a top view of a slide-in dowel of the slide-in fastening system, according to an embodiment of the invention.

FIG. 4C is a front view of a slide-in dowel of the slide-in fastening system, according to an embodiment of the invention.

FIG. 4D is a side view of a slide-in dowel of the slide-in fastening system, according to an embodiment of the invention.

FIG. 5A is a front view of an insert aperture of the slide-in fastening system, according to an embodiment of the invention.

FIG. 5B is a side view of an insert aperture of the slide-in fastening system, according to an embodiment of the invention.

FIG. 6A is a side view of a slide-in insert of the slide-in fastening system, according to an embodiment of the invention.

FIG. 6B is a front view of a slide-in insert of the slide-in fastening system, according to an embodiment of the invention.

FIG. 6C is a bottom perspective view of a slide-in insert of the slide-in fastening system, according to an embodiment of the invention.

FIG. 6D is a top perspective view of a slide-in insert of the slide-in fastening system, according to an embodiment of the invention.

FIG. 7A is a lateral cross-sectional view of a slide-in insert of the slide-in fastening system, according to an embodiment of the invention.

FIG. 7B is a lateral cross-sectional view of a slide-in insert of the slide-in fastening system, according to an embodiment of the invention.

FIG. 7C is a lateral cross-sectional view of a slide-in insert of the slide-in fastening system, according to an embodiment of the invention.

FIG. 7D is a lateral cross-sectional view of a slide-in insert of the slide-in fastening system, according to an embodiment of the invention.

FIG. 7E is a lateral cross-sectional view of a slide-in insert of the slide-in fastening system, according to an embodiment of the invention.

FIG. 8 is a front view of a slide-in insert of the slide-in fastening system, according to an embodiment of the invention.

FIG. 9A is a longitudinal cross-sectional view of a slide-in insert of the slide-in fastening system, according to an embodiment of the invention.

FIG. 9B is a longitudinal cross-sectional view of a slide-in insert of the slide-in fastening system, according to an embodiment of the invention.

FIG. 9C is a longitudinal cross-sectional view of a slide-in insert of the slide-in fastening system, according to an embodiment of the invention.

FIG. 9D is a longitudinal cross-sectional view of a slide-in insert of the slide-in fastening system, according to an embodiment of the invention.

FIG. 9E is a longitudinal cross-sectional view of a slide-in insert of the slide-in fastening system, according to an embodiment of the invention.

FIG. 10A is a top view of parts of a slide-in fastening system prior to shape manufacturing of slide-in dowels, according to an embodiment of the invention.

FIG. 10B is a top view of parts of a slide-in fastening system with slide-in dowels manufactured, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

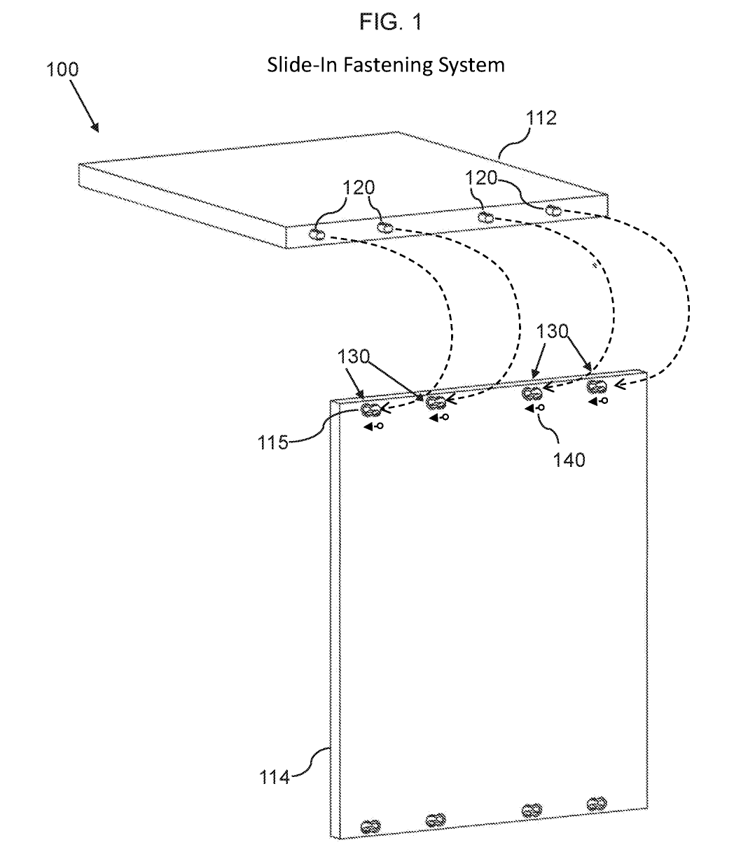

In the following, we describe the structure of an embodiment of a slide-in fastening system 100 for assembly of cabinets and other furniture with reference to FIG. 1, in such manner that like reference numerals refer to like components throughout; a convention that we shall employ for the remainder of this specification.

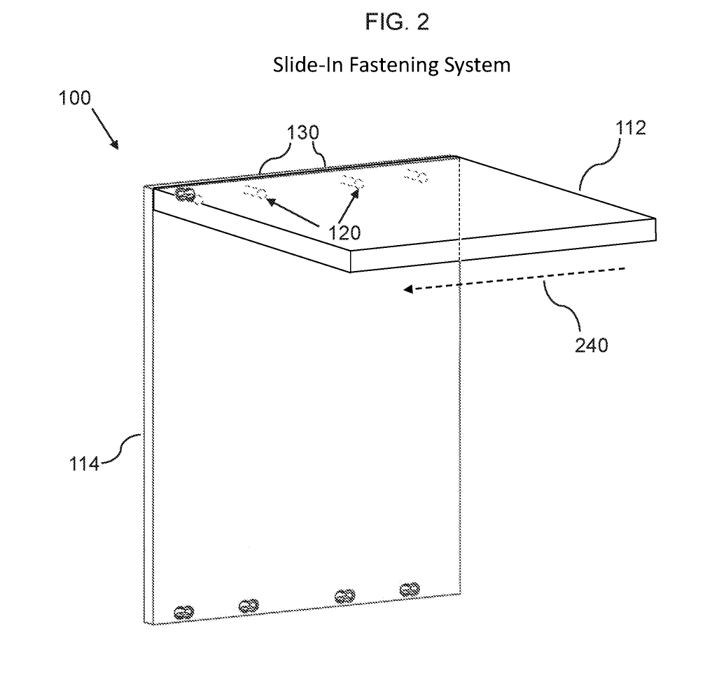

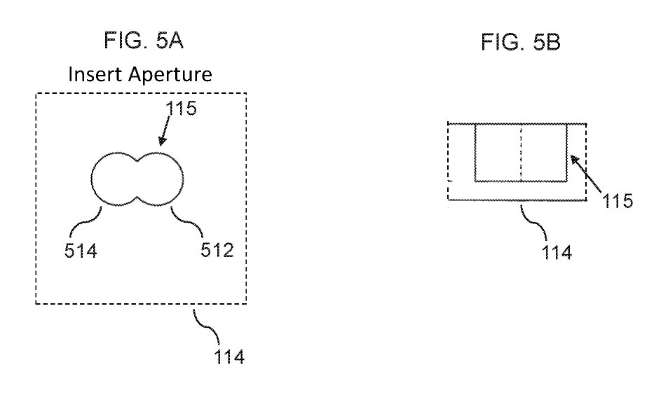

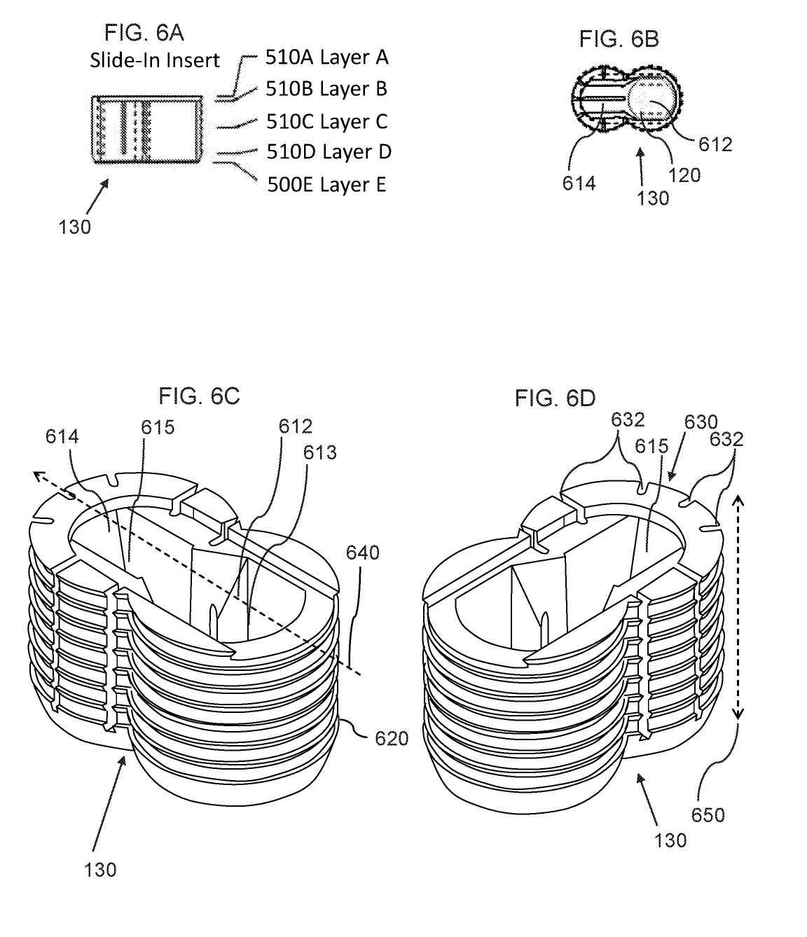

In an embodiment, a system for slide-in fastening 100 can include:
a) A first furniture member 112, which can be a first cabinet piece 112, such as a horizontal cabinet top/bottom 112, wherein the first furniture member 112 comprises:
   a plurality of slide-in dowels 120 protruding from an end of the first furniture member; and
b) A second furniture member 114, which can be a second cabinet piece 114, such as a vertical cabinet side 114, wherein the second furniture member 114 comprises:
   a plurality of slide-in inserts 130 each inserted in inserts apertures 115 that are positioned on an end of a side of the second furniture member 114;
wherein the insert apertures 115, as shown in FIGS. 5A and 5B, can be substantially figure-eight shaped, comprising overlapping first and second circular apertures 512 514, which can be of similar or different diameter, such that the insert apertures 115 serve to orient vertical alignment of the slide-in inserts 130;
wherein the slide-in inserts 130, as shown in FIGS. 6A, 6B, 6C, and 6D are figure-eight shaped and configured to be insertable into the insert apertures 115, as shown in FIGS. 5A and 5B, the slide-in inserts 130 each comprising a first opening 612, also called an entry opening 612, which connects to a first interior 613, also called an entry interior 613, and a second opening 614, also called a target opening 614, which connects to a second interior 615, also called a target interior 615, such that the entry and target interiors 613 615 are connected to form a combined interior 613 615 along an elongated direction 640 of each slide-in insert 130 (and similarly the entry and target openings 612 614 are connected to form a combined opening 612 614 along the elongated direction 640);
such that the first furniture member 112 is attachable to the second furniture member 114 by inserting each of the plurality of slide-in dowels 120 through a corresponding entry opening 612, such that each dowel 120 reaches into the corresponding entry interior 613 of a corresponding slide-in insert 120, and then push the first furniture member 112 sideways 140 240, in direction of and parallel to a lateral axis 640 of the slide-in insert 130, as shown in FIGS. 1 and 2, such that the slide-in dowels each slide from the corresponding entry interior 613 into a corresponding target interior 615, such that the dowels 120 are each securely held in place inside a corresponding target interior 615;
whereby, as shown in FIG. 2, the first furniture member 112 is securely attached to the second furniture member 114.

In related embodiments, the first and second furniture members 112 114 can be perpendicularly connected, such as shown in FIG. 2.

In related embodiments, the insert apertures 115, as shown in FIG. 5A, can be associated with a method of creating an elongated aperture, by drilling two intersecting/overlapping holes 512 514. The insert apertures 115 can thereby accommodate inserts of varying designs (i.e. be used for inserts other than the slide-in insert 130), which can be inserted with a well-defined vertical alignment.

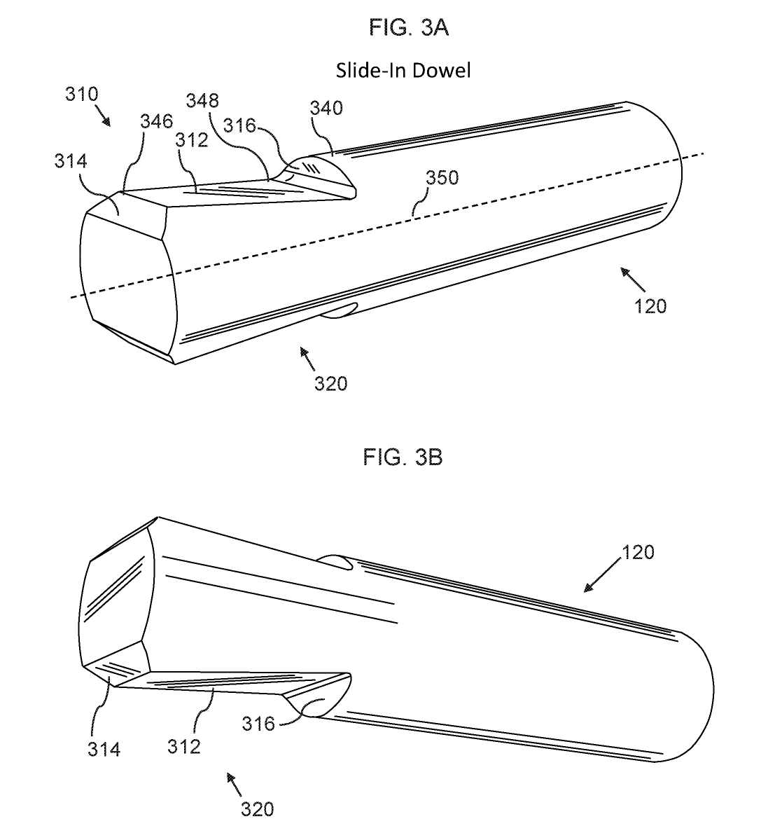

In a related embodiment, as shown in FIGS. 3A and 3B, a slide-in dowel 120 can be configured as a cylindrical member including a top front cutout 310 and a bottom front cutout 320, each comprising:
a) a cutout surface 312, which cuts at an angle so that the slide-in dowel narrows from a front 346 of the cutout surface 312 to a rear 348 of the cutout surface 312;
b) an entry cut 314, which is a front cut that connects with a front of the cutout surface 312, such that the entry cut 314 is configured to ease insertion of the slide-in dowel; and
c) a rear cut 316, which connects with a rear of the cutout surface 312 to reach the rear surface 340 of the slide-in dowel 120;
wherein the top and bottom front cutouts 310 320 are symmetrical around a center axis 350 of the slide-in dowel.

In a further related embodiment, the slide-in dowel 120 can be up-down asymmetrical, comprising only one of a top/first front cutout 310 or a bottom/second front cutout 320, such that an opposite side to the top front cutout 310 or bottom front cutout 320 is an unmodified rounded/cylindrical dowel surface.

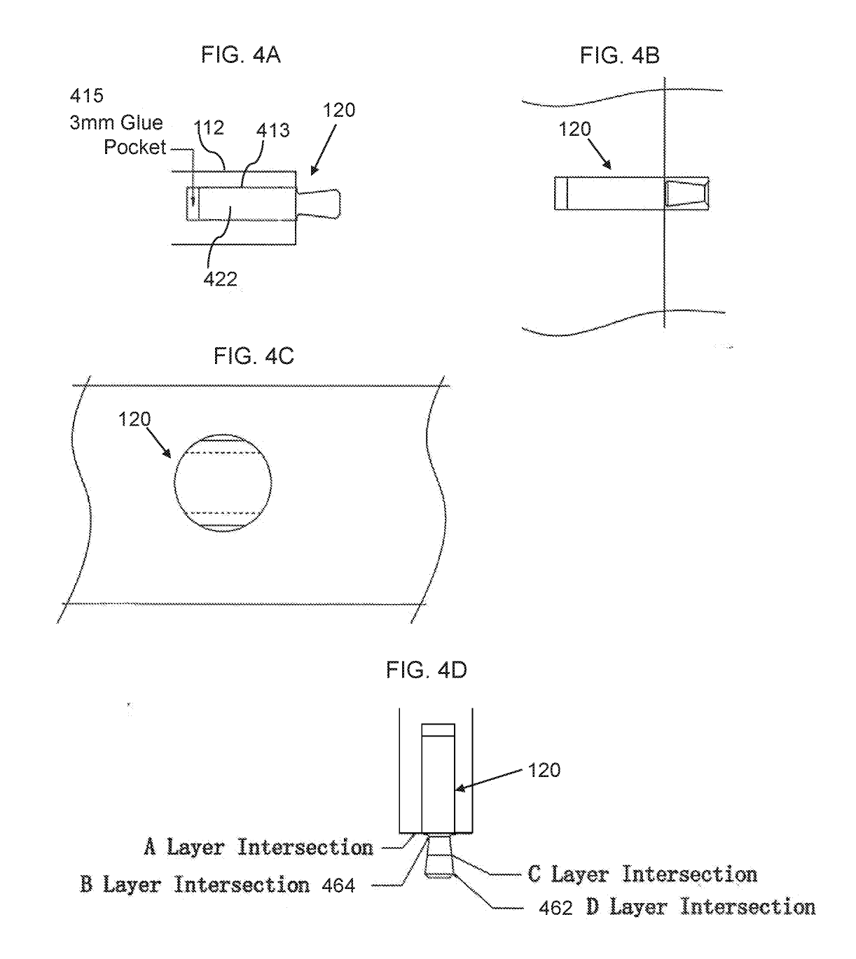

In a related embodiment, as shown in FIG. 4A, a rear end 422 of the slide-in dowel 120 can be permanently connected to the first furniture member 112, by insertion of the rear end 422 into a predrilled aperture 413 of the first furniture member 112, with a glue pocket/deposit 415 inserted in a bottom of the predrilled aperture. FIGS. 4B and 4C show respectively top and front views of the slide-in dowel 120.

In a related embodiment, FIG. 4D shows a side view of the varying vertical width of the front of the slide-in dowel 120 between the top and bottom front cutouts 310 320, going from a front maximum width 462 to a minimum width 464.

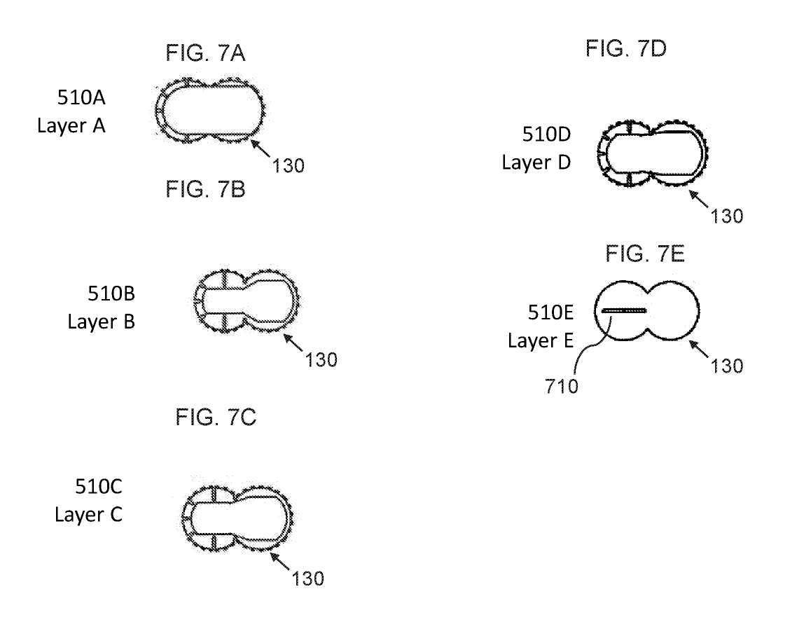

In a related embodiment, FIGS. 6A-6D and 7A-7E shows, in lateral sectional cuts, that the target interior gradually expands, from an outer side in layer B 510B, shown in FIGS. 6A and 7B, to an inner side in layer D 510D, shown in FIGS. 6A and 7D, such that the shape of a front end of a slide-in dowel 120 with top front cutout 310 and a bottom front cutout 320 is configured to match with the shape of the target interior, such that when the slide-in dowel is pushed sideways from the entry interior 613 into the target interior 615, the slide-in dowel 120 will be pulled inwards to reach the matching shape of the target interior, whereby the slide-in dowel 120 is securely and tightly connected in the target interior 615. The inward pull of a plurality of slide-in dowels 120 will thereby ensure that the first and second furniture members 112 114 are pulled tightly and securely together, as shown in FIG. 2.

In a further related embodiment, as shown in FIG. 7E, a bottom of the target interior 615 can include a bottom elongated guide protrusion 710, which is configured to adjust a position of the slide-in dowel 120 and ensure that the slide-in dowel 120 can be moved into the target interior 615 with minimal friction. In some embodiments the target interior 615 may not have a bottom, such that the target interior 615 protrudes through the slide-in insert 130.

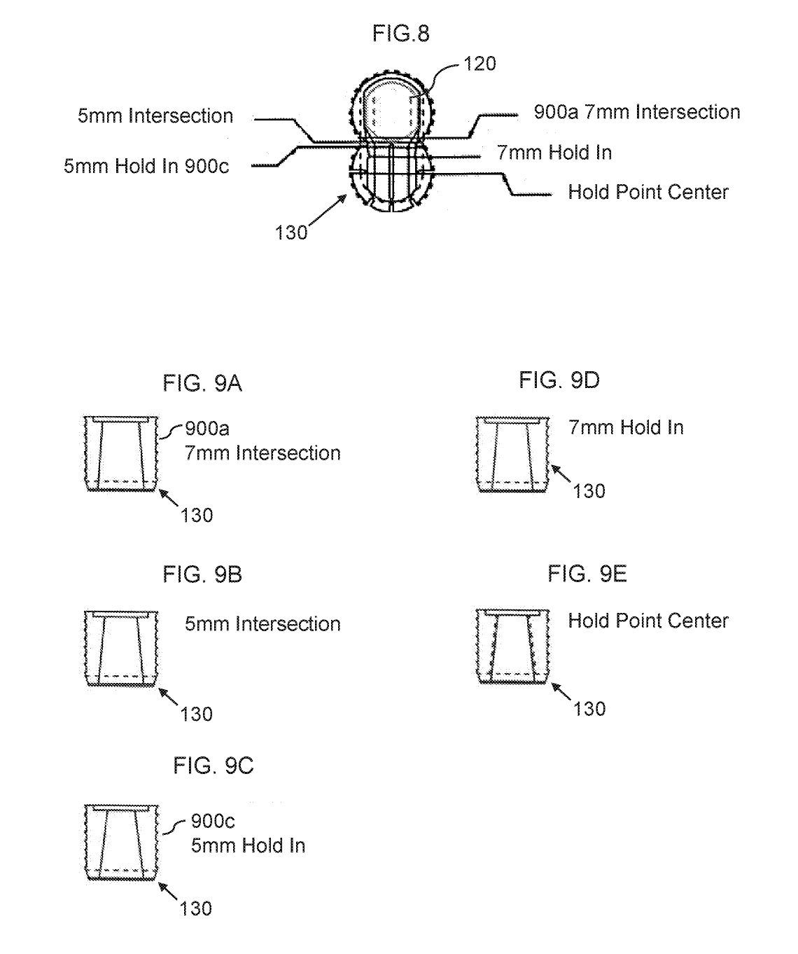

In a related embodiment, FIGS. 8 and 9A-9E shows, in longitudinal sectional cuts, that the target interior provides a side opening that narrows from a 7 mm intersection position 900a, shown in FIG. 9A, towards a minimum 5 mm hold in position 900c, shown in FIG. 9C, and then expands, as shown in FIGS. 9D and 9E, such that the slide-in dowel 120 is securely held in position when the slide-in dowel 120 slides past the 5 mm hold in position 900c. Other sizing can be applied, the specific dimensions provided here are merely exemplary. FIGS. 6B and 8 show the slide-in insert 130 with the slide-in dowel 120 inserted into the entry interior 613.

In a related embodiment, as shown in FIG. 6C, the slide-in insert 130 can have serrated edges 620, which can also be referred to as ribbed edges 620, on sides of the slide-in insert 130, such that the serrated edges 620 help secure the slide-in insert 130 inside the insert aperture 115.

In a further related embodiment, the target interior 615 can be configured with a size that matches the slide-in dowels 120, such that the slide-in insert 130 expands slightly when the slide-in dowels 120 is pushed into the target interior 615, whereby the slide-in insert 130 is further secured inside the insert aperture 115, as the serrated edges expand into inner sides of the insert apertures 115. The slide-in insert 130 expands throughout the entire length 650 of a target portion 630 of the slide-in insert 130, around an entire length 650 of the target interior 615.

In a yet further related embodiment, the slide-in insert 130 can further include expansion slits 632 on an outer surface of the slide-in insert 130. The expansion slits can as shown be positioned solely on an outer surface of the target portion 630 of the slide-in insert 130. The expansion slits 632 can be located to control the expanding portions of the slide-in insert 130, such that omission of expansion slits 632 can ensure a substrate 114 is only compressed in areas of sufficient strength.

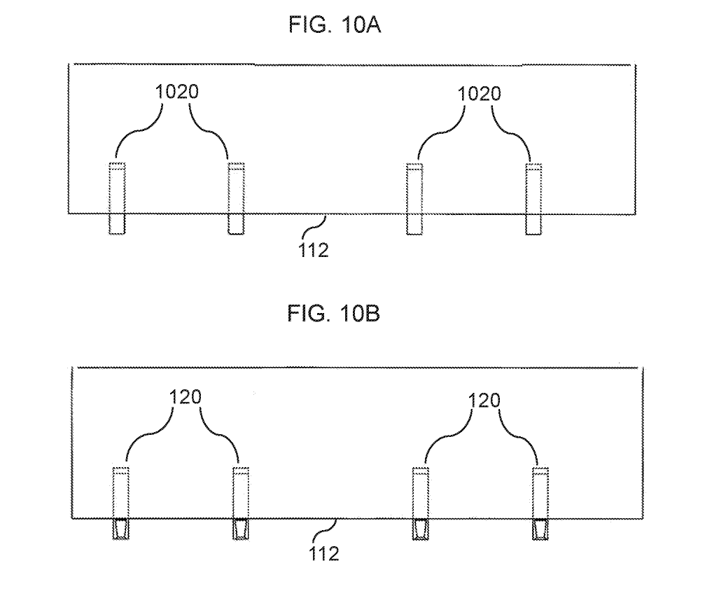

In a related embodiment, as shown in FIGS. 10A and 10B, a method of manufacturing slide-in dowels 120, can comprise:
a) Inserting cylindrical dowels 1020 into a furniture member 112, wherein the cylindrical dowels 1020 are conventional dowels, shaped as solid cylindrical rods, for example made of wood or plastic, such that the dowels 1020 are glued into predrilled apertures, as shown in FIG. 10A;
b) Machining the exposed end of the cylindrical dowels 1020, to create the top front cutout 310 and a bottom front cutout 320, for example using a cutting or grinding tool, such that the cylindrical dowels 1020 are transformed to slide-in dowels 120, as shown in FIG. 10B.

In various related embodiments, the system for slide-in fastening 100 can:
a) Enable drilling multiple overlapping holes for parallel alignment versus machining a slot, thereby allowing much faster manufacturing
b) Allow machining/shaping of round dowels 1020 after dowels 1020 are inserted into host material for the purpose of creating precision parallel or perpendicular alignment and precise machining characteristics relative to host material;
c) Create significant compression and prohibit perpendicular pullout due to dovetail shape of the slide-in insert 130;
d) Allow glue-less assembly of products, without use screws and/or CNC Routers
e) Allow compression connectors to be hidden without use of CNC routers

Here has thus been described a multitude of embodiments of the system for slide-in fastening 100, including devices and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for slide-in fastening, comprising:
a) a first furniture member, comprising:
a plurality of slide-in dowels, which are protruding from an end of the first furniture member; and
b) a second furniture member, comprising:
a plurality of insert apertures, which are positioned on an end of a side of the second furniture member; and
a plurality of slide-in inserts, wherein each slide-in insert is inserted in a corresponding insert aperture in the plurality of insert apertures;
such that the first furniture member is attachable to the second furniture member by inserting a corresponding slide-in dowel of the plurality of slide-in dowels through a corresponding entry opening, such that the corresponding slide-in dowel reaches into a corresponding entry interior of a corresponding slide-in insert, and then push the first furniture member sideways, in direction of and parallel to a lateral axis of the slide-in insert, such that the corresponding slide-in dowel is securely held in place inside a corresponding target interior;
whereby the first furniture member is securely attached to the second furniture member.

2. The system for slide-in fastening of claim 1, wherein the insert apertures are substantially figure-eight shaped, each comprising overlapping first and second circular apertures, such that the insert apertures serve to orient vertical alignment of the slide-in inserts.

3. The system for slide-in fastening of claim 2, wherein diameters of the first and second circular apertures are similar.

4. The system for slide-in fastening of claim 2, wherein each slide-in insert comprises:
a) an entry opening;
b) an entry interior, such that the entry opening connects to the entry interior;
c) a target opening; and
d) a target interior, such that the target opening connects to the target interior;
wherein the entry and target interiors are connected to form a combined interior along an elongated direction of each slide-in insert, such that the corresponding slide-in dowel is configured to slide from the corresponding entry interior into the corresponding target interior.

5. The system for slide-in fastening of claim 1, wherein the first and second furniture members are perpendicularly connected.

6. The system for slide-in fastening of claim 4, wherein each slide-in dowel is configured as a cylindrical member, which comprises a top front cutout and a bottom front cutout, each of the top and bottom front cutouts comprising:
a cutout surface, which cuts at an angle such that each slide-in dowel narrows from a front of the cutout surface to a rear of the cutout surface.

7. The system for slide-in fastening of claim 4, wherein each slide-in dowel is configured as a cylindrical member, which comprises solely one cutout, comprising:
a cutout surface, which cuts at an angle such that each slide-in dowel narrows from a front of the cutout surface to a rear of the cutout surface.

8. The system for slide-in fastening of claim 6, wherein each of the top and bottom front cutouts further comprise:
a) an entry cut, which is a front cut that connects with a front of the cutout surface, such that the entry cut is configured to ease insertion of the slide-in dowels; and
b) a rear cut, which connects with a rear of the cutout surface to reach a rear surface of the corresponding slide-in dowel.

9. The system for slide-in fastening of claim 1, wherein the first furniture member further comprises:
predrilled apertures with glue deposits in bottoms of the predrilled apertures;
wherein rear ends of the slide-in dowels each are permanently connected to the first furniture member, by insertion of the rear ends into the predrilled apertures with the glue deposits.

10. The system for slide-in fastening of claim 6, wherein the target interior gradually expands, from an outer side to an inner side, such that the shape of a front end of the corresponding slide-in dowel with the top front cutout and the bottom front cutout is configured to match with the shape of the target interior, such that when the corresponding slide-in dowel is pushed sideways from the entry interior into the target interior, the corresponding slide-in dowel is pulled inwards to reach the matching shape of the target interior, whereby the corresponding slide-in dowel is securely and tightly connected in the target interior.

11. The system for slide-in fastening of claim 4, wherein the target interior further comprises a bottom, which further comprises a bottom elongated guide protrusion, which is configured to adjust a position of the corresponding slide-in dowel and ensure that the corresponding slide-in dowel is moveable into the target interior with minimal friction.

12. The system for slide-in fastening of claim 4, wherein the target interior is configured with a side opening that narrows from an intersection position, towards a minimum hold in position, and then expands, such that the corresponding slide-in dowel is securely held in position when the corresponding slide-in dowel slides past the minimum hold in position.

13. The system for slide-in fastening of claim 4, wherein each slide-in insert is configured with ribbed edges, which are positioned on sides of each slide-in insert, such that the ribbed edges are configured to secure the corresponding slide-in insert inside the corresponding insert aperture.

14. The system for slide-in fastening of claim 13, wherein the target interior is configured with a size that matches the slide-in dowels, such that the corresponding slide-in insert is configured to expand when the corresponding slide-in dowel is pushed into the target interior, whereby the corresponding slide-in insert is further secured inside the insert aperture, as the ribbed edges expand into inner sides of the insert apertures, throughout an entire length of the target portion of the slide-in insert, around an entire length of the target interior.

15. The system for slide-in fastening of claim 14, wherein the corresponding slide-in insert further comprises a plurality of expansion slits on an outer surface of the slide-in insert.

16. A system for slide-in fastening, comprising:
a) a plurality of slide-in dowels, which are configured to protrude from an end of a first furniture member; and
b) a plurality of slide-in inserts, wherein each slide-in insert is configured to be inserted in a corresponding insert aperture on an end of a side of a second furniture member;
such that the first furniture member is attachable to the second furniture member by inserting a corresponding slide-in dowel of the plurality of slide-in dowels through a corresponding entry opening, such that the corresponding slide-in dowel reaches into a corresponding entry interior of a corresponding slide-in insert, and then push the first furniture member sideways, in direction of and parallel to a lateral axis of the slide-in insert, such that the corresponding slide-in dowel is securely held in place inside a corresponding target interior;
whereby the first furniture member is securely attached to the second furniture member.

17. The system for slide-in fastening of claim 16, wherein each slide-in dowel is configured as a cylindrical member, which comprises a top front cutout and a bottom front cutout, each of the top and bottom front cutouts comprising:
a cutout surface, which cuts at an angle such that each slide-in dowel narrows from a front of the cutout surface to a rear of the cutout surface.

18. A method of manufacturing slide-in dowels, comprising:
a) inserting cylindrical dowels into predrilled apertures of a furniture member, wherein the predrilled apertures are filled with glue, such that the cylindrical dowels are glued into the predrilled apertures;
b) machining exposed ends of the cylindrical dowels, to create for each cylindrical dowel a top front cutout and a bottom front cutout, such that the cylindrical dowels are transformed to slide-in dowels.

19. The method of manufacturing slide-in dowels of claim 18, wherein for each slide-in dowel, each of the top and bottom front cutouts are machined to comprise:
a cutout surface, which cuts at an angle such that a corresponding slide-in dowel narrows from a front of the cutout surface to a rear of the cutout surface.

20. The method of manufacturing slide-in dowels of claim 19, wherein each of the top and bottom front cutouts are machined to further comprise:
a) an entry cut, which is a front cut that connects with a front of the cutout surface, such that the entry cut is configured to ease insertion of the corresponding slide-in dowel; and
b) a rear cut, which connects with a rear of the cutout surface to reach the rear surface of the corresponding slide-in dowel.
